(19) United States
(12) Patent Application Publication
(10) Pub. No.: US 2026/0285387 A1
(43) Pub. Date: Sep. 24, 2026

(54) STROLLER

(71) Applicant: AVALEX PTE. LTD., SINGAPORE (SG)

(72) Inventor: Ivan PRUSHKO, Lutsk (UA)

(21) Appl. No.: 19/576,951

(22) Filed: Mar. 24, 2026

(30) Foreign Application Priority Data
Mar. 24, 2025 (UA) A 2025 01257
Dec. 16, 2025 (UA) A 2025 06291

(51) Int. Cl. B62B 7/08; B62B 7/00; B62B 7/06; B62B 7/14; B62B 9/18; B62B 9/20

(52) U.S. Cl. CPC B62B 7/083; B62B 7/008; B62B 7/064; B62B 7/142; B62B 9/18; B62B 9/20

(57) ABSTRACT

The invention relates to field of manually driven transport and concerns a baby stroller. The proposed solution solves a task of extended variability of mounting, on a single stroller frame, of one and/or two receiving devices of different type, size, weight and orientation, while maintaining the dimensions of the stroller and ensuring compactness of its folding. Said variability is achieved due to three pairs of adapters arranged on the stroller frame.

### CROSS-REFERENCE TO RELATED APPLICATIONS

This application claims priority to Ukrainian Application Nos. a 2025 06291, filed Dec. 16, 2025; and a 2025 01257, filed Mar. 24, 2025; which are hereby incorporated by reference in their entirety.

### FIELD OF THE INVENTION

The claimed invention relates to field of manually driven transport and concerns a baby stroller.

### BACKGROUND

There are various structures of strollers intended for transporting one or several children, the strollers comprise a frame consisting of several supports with front and rear wheels, handle supports, as well as various receiving devices.

During operation of prior art strollers, a problem of combining preservation of the stroller dimensions, convenience of folding and unfolding with a large amount of variability in the arrangement of receiving devices remains relevant. Many structures are limited to a small number of fixed seating positions or levels, thereby requiring to use separate connectors between adapters and receiving devices, additional intermediate frames or brackets, which complicates the structure, increases the number of separate parts, may result in mutual interference of the receiving devices with each other, complicates optimal distribution of load on the frame and does not always ensure sufficient stability and maneuverability of the stroller, especially when using receiving devices of increased weight or when transporting two children.

The Applicant is aware of several technical solutions that are directed to solve this problem with the following ones being the closest in terms of a set of essential features.

Application WO2024030480A1 dated Feb. 8, 2024 discloses a baby stroller comprising a frame consisting of supports of front wheels, supports of the rear wheels, and supports of a handle, wherein the supports of the front wheels and the supports of the handle are hingedly connected. At the same time, the stroller frame comprises two pairs of adapters for mounting receiving devices, the first pair of adapters is interconnected by a post, is slidable, comprises two positions and is located between the supports of the rear wheels, and the second pair of adapters is located either directly above the front wheels or fixed in mounting assemblies of the front wheels outside the supports of the front wheels. A drawback of this technical solution lies in limitation in the variability of arrangement of the receiving devices due to arrangement of the adapters, which are spatially spaced. Another drawback is the structural implementation of the first pair of adapters, which comprise sliding mechanisms, which requires high manufacturing accuracy of the guides and retainers, which during operation become contaminated and, thus, lead to jamming or sticking. Wear of the fixing elements may cause incomplete fixation of the adapters and their spontaneous displacement under the action of dynamic loads. Another disadvantage is use of additional connectors on the adapters for attachment of various receiving devices, which increases the number of components, manipulations and complicates use, as well as increases the weight of the stroller.

Application US2014333039A1 dated Nov. 13, 2014 discloses a baby stroller comprising a frame consisting of supports of front wheels, which are hingedly connected to supports of a handle and supports of rear wheels. At the same time, the stroller frame comprises two pairs of adapters for mounting of receiving devices, the first pair of adapters is located on the handle supports and is non-removable, and the second pair of adapters is removable and mounted in mounting locations arranged on the supports of the front wheels, namely above the front wheels. Although this structure ensures greater variability of arrangement of the devices, a drawback of this technical solution lies in increase of dimensions of the stroller and complication of mounting and dismounting. Another drawback is the structural implementation and arrangement of the lower pair of adapters, which increases the number of manipulations for folding, unfolding and use of the stroller, as well as concentrates vertical loads from the receiving device mounted thereon precisely in a zone of mounting of the front wheels, creating increased bending moments in the supports of the front wheels, which requires reinforcement of the front part of the frame, thereby increasing weight and material consumption of the structure.

Application WO2021052928A1 dated Mar. 25, 2021 discloses a baby stroller comprising a frame consisting of supports of front wheels, supports of the rear wheels, and supports of a handle that is coupled to a telescopic handle, wherein the supports of the front wheels and the supports of the handle are hingedly connected. At the same time, the stroller frame comprises two pairs of adapters for installation of receiving devices, wherein the first pair of adapters is arranged on the handle supports, is slidable and has two positions, and the lower pair of adapters is arranged on the supports of the front wheels and may be either removable or non-removable. A drawback of this technical solution is the limitation of variability of arrangement of the receiving devices, caused by the structural implementation and placement of the adapters. In particular, use of sliding mechanisms in the first pair of adapters provides for movement along guides with fixation in two positions, which requires high manufacturing accuracy of the sliding surfaces and retainers. During operation of the stroller, the guides inevitably become contaminated, which results in jamming, sticking or, conversely, appearance of a play in the sliding mechanism. Wear of the fixing elements results in incomplete fixation of the adapters in the specified position and their spontaneous displacement during operation, thereby reducing reliability and safety of transportation of a child. In addition, the lower pair of adapters structurally limits the variability of installation of receiving devices, since they occupy space in a lower zone of the frame, and this implementation of the adapters constitutes an obstacle on which both a child and a user may catch.

Patent CN221068188U dated Jun. 4, 2024 discloses a baby stroller comprising a frame consisting of supports of front wheels, supports of the rear wheels, and supports of a handle that is coupled to a telescopic handle, wherein the supports of the front wheels and the supports of the handle are hingedly connected. At the same time, the stroller frame comprises two pairs of adapters for installation of receiving devices, wherein the first pair of adapters is arranged on the handle supports, is slidable and has two positions, and the lower pair of adapters is removably coupled to locations for fixation of the adapters, which are arranged on the supports of the front wheels, wherein the lower pair of adapters comprises a position adjustment mechanism. A drawback of this technical solution is the limitation of variability of arrangement of the receiving devices, caused by the structural implementation and arrangement of the adapters. An additional significant drawback is the sliding adapters, since during operation of the stroller, the guides become contaminated with dust, sand, fabric fibers, rainwater, etc., which results in their jamming, sticking, and the appearance of a play. Wear or breakage of the fixing elements of the sliding mechanism leads to incomplete and unreliable fixation of the adapter in one of the positions. Under conditions of dynamic loads, for example, driving onto a curb, potholes, or sudden braking, this creates a risk of spontaneous displacement of the adapter and, thus, spontaneous disengagement from the position or partial detachment of the receiving device in which the child is located, thereby negatively affecting overall safety of the structure.

Thus, there is a need for improvement of the stroller, which would combine a large number of options for installation of various receiving devices, while preserving the stroller dimensions, as well as ensuring safety of the structure and simplicity of folding/unfolding for convenience of operation.

### SUMMARY OF THE INVENTION

The claimed invention is based on a desire to provide a stroller of small dimensions, while ensuring a possibility of increased variability of mounting, on a stroller frame, of receiving devices of different type, size, weight, and orientation by means of their arrangement within a single plane formed by supports of front wheels and supports of handle, without changing the dimensions of the stroller frame, as well as with a possibility of compact folding and unfolding, suitable for transporting one or two children of different age and weight, as well as cargo or pets.

Embodiments of the subject invention provide a stroller comprising a frame that comprises supports of front wheels, supports of rear wheels, and supports of a handle. The supports of the front wheels and the supports of the handle are coupled by means of hinge assemblies with a possibility of changing and fixing a frame position in folded or unfolded positions. Adapters are fixed on the frame, the adapters are configured such that receiving devices can be mounted thereon.

According to the invention, the stroller comprises three pairs of adapters, wherein the first pair of adapters is upper, the second pair of adapters is middle, and the third pair of adapters is lower. Therewith, at least one pair of the upper or middle adapters is arranged on the supports of the handle and at least one pair of the upper or middle adapters is removable.

The pair of lower adapters is arranged from inside of the supports of the front wheels in close vicinity to the front wheels and is made non-removable, and each lower adapter comprises a pivot mechanism that is configured to change a position of the lower adapters, wherein, in an operation position, the lower adapters are oriented upwards relative to the supports of the front wheels.

The non-removability of the lower adapters inhibits their sudden loss during operation, transportation, or folding of the stroller, since they always remain rigidly fixed on the supports of the front wheels and do not require a user to perform any additional actions as to their mounting or removal. This increases reliability of the structure and simplifies use of the product by eliminating a need in controlling individual fine elements.

Provision of the lower adapters with pivot mechanisms ensures versatility of the stroller structure and allows to use it both for one child and for two children by mounting different receiving devices in different orientations and combinations. In the operation position, the lower adapters are oriented upwardly relative to the supports of the front wheels, thereby allowing mounting of the receiving devices thereon, creates an additional supporting plane and increases stability of the structure when using modules of increased weight.

Three pairs of adapters provide the following six configurations of the operation positions of the adapters:
(i) the upper pair of adapters, the middle pair of adapters, and the lower pair of adapters are in a position that is opposite to the operation position;
(ii) the middle pair of adapters and the lower pair of adapters are in the operation position;
(iii) the upper pair of adapters and the lower pair of adapters are in the operation position;
(iv) the middle pair of adapters and the lower pair of adapters are in a position that is opposite to the operation position;
(v) the middle pair of adapters and the lower pair of adapters are in a position that is different from the operation position or in a position that is opposite to the operation position;
(vi) the upper pair of adapters, the middle pair of adapters, and the lower pair of adapters are in the operation position.

This design ensures formation of a wide range of options for arrangement of the receiving devices, in particular, mounting of one or two receiving devices of different types, variation of their orientation, optimization of load distribution on the frame, prevention of mutual interference of the receiving devices, and ensuring stability of the stroller during operation in any of the provided configurations.

A technical effect of this design lies in expansion of functional capabilities of the stroller due to the arrangement of the adapters, which have a structural implementation and mutual positioning that ensure a high variability of simultaneous or selective mounting of one and/or two receiving devices for placement of one child of different age and weight, or two children of the same and/or different age and weight, or for placement of cargo or animals, with a possibility of varying the orientation of the mounted receiving devices relative to a movement direction of the stroller. Also, the technical effect lies in increase of stability and balance of the stroller structure under the action of load from the receiving devices of different weight due to ensuring immobility and impossibility of accidental detachment or displacement of the adapters in the operation and non-operation positions and, thus, increase of operational safety.

According to a preferable exemplary embodiment of the invention, the receiving device is a cradle or a safety seat or a bucket. This design enables to use the stroller for different ages of the children, as well as pets, and allows to change the stroller configuration quickly depending on user needs.

According to another exemplary embodiment of the invention, the receiving device is a walking unit comprising a seat and a back that are connected by hinge assemblies, wherein the back is configured to adjust an inclination angle relative to the seat, and the walking unit is configured to be mounted in two orientations relative to the movement direction of the stroller. This design allows to adapt the walking unit to needs of the child, ensures comfort and safety, as well as allows to arrange the child facing the parents or in the movement direction.

According to another exemplary embodiment of the invention, the walking unit is made foldable and unfoldable together with the frame in two orientations. This design simplifies use of the product, reduces time and decreases the number of manipulations during folding and unfolding of the stroller, and facilitates its transportation owing to ensuring the possibility of folding the frame into a compact size with one or two mounted walking units regardless of their orientation.

According to another exemplary embodiment of the invention, the receiving device is a wagon that consists of a wagon frame that is made of at least two half-frames that are interconnected by hinges with the possibility of changing and fixing an inclination angle of each half-frame, a barrier, and being equipped with at least one seating place. This design ensures the possibility of placement of one or two children, allows changing the spatial configuration of the wagon according to user needs, and ensures safe transportation of children.

According to another exemplary embodiment of the invention, the wagon is foldable and unfoldable together with the frame, thereby ensuring compactness in a folded state and facilitating both storage and transportation of the stroller.

According to another exemplary embodiment of the invention, the upper pair of adapters and the middle pair of adapters are arranged on the supports of the handle above the folding hinge assemblies, thereby improving the spatial arrangement and avoiding mutual contact between the receiving devices.

According to another exemplary embodiment of the invention, the middle pair of adapters is arranged from inside on the folding hinge assemblies.

According to another exemplary embodiment of the invention, in a position that is opposite to the operation position, the lower adapters are oriented downwards relative to the supports of the front wheels. This design ensures the possibility of forming additional configurations of the operation positions of the upper and middle pairs of adapters, which allows to optimize the spatial arrangement of the receiving devices and to form other configurations of mounting of the receiving devices, including simultaneous mounting of two receiving devices of different type.

According to another exemplary embodiment of the invention, in a position that is different from the operation position, the lower adapters are oppositely oriented. With this design, the visual appearance of the stroller is improved, and the probability of catching them with the user's legs or foreign objects during movement is reduced, thereby increasing operation safety of the stroller and reducing risks of injury.

According to another exemplary embodiment of the invention, the handle supports comprise a mechanism for adjusting the inclination angle of the handle, which allows the user to adapt the position of the handle to height and convenience, thereby increasing ergonomics of control of the stroller.

According to another exemplary embodiment of the invention, the handle supports are connected to the supports of the rear wheels by shock-absorber supports, thereby ensuring increase of smoothness of travel, cushioning of road irregularities, while maintaining stability and rigidity of the structure.

An advantage of this structural solution is versatility and convenience of use of the stroller as a single-seat and as a double-seat stroller, which provides operational advantages, since it eliminates a need to purchase and store several separate strollers for different purposes, reduces occupied space in residential and transport conditions, as well as ensures quick change of configurations in accordance with current needs of the family, birth of a second child, change of age or weight of children, necessity of mounting various receiving devices, which may be used not only for children, but also for cargo, animals, etc.

### BRIEF DESCRIPTION OF THE DRAWINGS

In order to provide more complete understanding of the claimed invention and advantages thereof, the following description provides an explanation of a possible implementation thereof with a reference to figures of the appended drawings, wherein identical designations denote identical parts, and which illustrate the following:

FIG. 1 shows a general view of the stroller with three pairs of adapters,

FIG. 2 shows a general view of the stroller with three pairs of adapters,

FIG. 3 shows a general view of the stroller with three pairs of adapters,

FIG. 4 shows the stroller in the configuration (i),

FIG. 5 shows the stroller in the configuration (ii),

FIG. 6 shows the stroller in the configuration (iii),

FIG. 7 shows the stroller in the configuration (iv),

FIG. 8 shows the stroller in the configuration (v),

FIG. 9 shows the stroller in the configuration (vi),

FIG. 10 shows two walking units which are folded in a single piece together with the stroller frame,

FIG. 11 shows the wagon that is folded in a single piece together with the stroller frame.

### MAIN DESIGNATIONS

1. stroller,
2. supports of the rear wheels,
3. supports of the front wheels,
4. supports of the handle,
5. mechanism for adjusting the inclination angle,
6. handle,
7. folding hinge assemblies,
8. upper pair of adapters,
9. middle pair of adapters,
10. lower pair of adapters,
11. pivot mechanism,
12. cradle,
13. safety seat,
14. bucket,
15. walking unit,
16. seat,
17. back,
18. hinge assemblies,
19. wagon,
20. half-frames,
21. hinges,
22. barrier,
23. seating place,
24. shock-absorber supports.

The illustrative materials that explain the claimed invention and the disclosed specific exemplary embodiments do not limit the claimed scope of rights in any way, rather they only explain the essence of the invention.

### DETAILED DESCRIPTION

A stroller (1) comprising a frame that comprises supports (2) of rear wheels, supports (3) of front wheels, and supports (4) of a handle, wherein the supports (3) of the front wheels and the supports (4) of the handle are coupled via folding hinge assemblies (7) with a possibility of changing and fixing a position of the frame in folded or unfolded states.

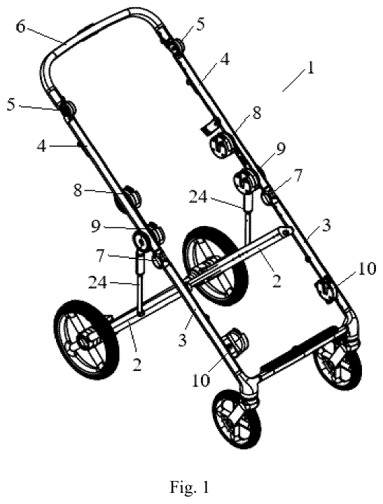

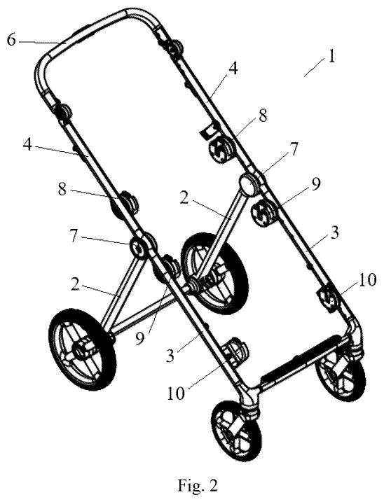

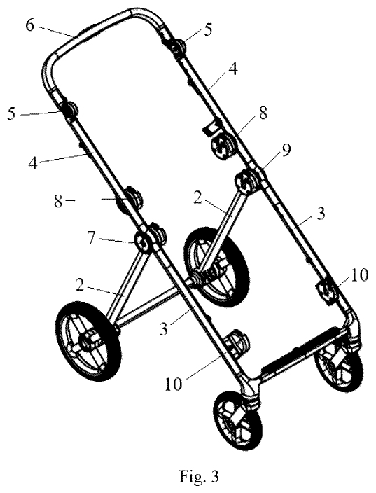

The frame of the stroller (1) comprises three pairs (8, 9, 10) of adapters, wherein the first pair of adapters is upper (8), the second pair of adapters is middle (9), and the third pair of adapters is lower (10). In this exemplary embodiment, the upper pair (8) of adapters and the middle pair (9) of adapters are arranged on the supports (4) of the handle above the folding hinge assemblies (7) as shown in FIG. 1. Therewith, the upper pair (8) of adapters and the middle pair (9) of adapters also may be arranged separately on the supports (4) of the handle or, e.g., on shared plane brackets. This configuration ensures precise arrangement of the fasteners relative to each other. Besides, this arrangement significantly simplifies a manufacturing process, since use of the unified plane brackets reduces a number of individual components, simplifies a quality control process, and allows to mount the fasteners quickly during manufacturing. In another exemplary embodiment, the upper pair (8) of adapters is arranged on the supports (4) of the handle above the folding hinge assemblies (7), while the middle pair (9) of adapters is arranged on the supports (3) of the front wheels below the folding hinge assemblies (7) as shown in FIG. 2. In another exemplary embodiment, the upper pair (8) of adapters is arranged on the supports (4) of the handle above the folding hinge assemblies (7), while the middle pair (9) of adapters is arranged from inside on the folding hinge assemblies (7) as shown in FIG. 3. Therewith, at least one pair of the upper (8) and middle (9) adapters is removable. Said configuration is merely an exemplary embodiment of the invention, and it does not limit possible options of arrangement and fixation of the upper pair (8) of adapters and the middle pair (9) of adapters.

The pair of lower adapters (10) is arranged from inside of the supports (3) of the front wheels in close vicinity to the front wheels and is made non-removable, and each lower adapter (10) comprises a pivot mechanism (11) that is configured to change a position of the lower adapters (10), wherein, in an operation position, the lower adapters (10) are oriented upwards relative to the supports (3) of the front wheels. The pivot mechanism (11) may be a hinged or axial connection and it may comprise at least one axis or rotation stud mounted in corresponding openings or sleeves of the supports (3) of the front wheels and/or lower adapters (10). If necessary, the pivot mechanism (11) may comprise rotation angle delimiters, resilient elements, e.g., a torsion or plane spring, as well as retainers, e.g., gates, toothed sectors, latches, etc., which retain each lower adapter (10) in a given position.

The adapters (8, 9, 10) are intended for removably connecting the receiving devices, and they may have any shape and dimensions. In the drawings, the adapters are shown as having a circular shape, however, this does not limit the invention, since they may have, for example, elliptical, oval, polygonal, or other arbitrary shape. The adapters (8, 9, 10) may be made in the form of pins, studs, hooks, brackets, sockets, bushings, shelves, frames, guide profiles, Π, L- or U-shaped elements, or combinations thereof. A surface of the adapters (8, 9, 10) may be provided with recesses, grooves, and the receiving devices may be provided with corresponding protrusions, retainers, resilient elements, etc. may be provided, which interact with each other and ensure easy connection and disconnection of the receiving devices with the adapters, as well as their reliable fixation in the operation position. For example, each adapter (8, 9, 10) may comprise a mechanism for fixation of the adapter, a button for removal of the receiving device for easy and quick detachment. Also, the adapters (8, 9, 10) may be either a part of the stroller frame or a part of the receiving devices.

According to the general concept of the invention, the adapters (8, 9, 10) arranged on the stroller frame (1) are made versatile and intended for mounting of various receiving devices thereon. The structure of the adapters (8, 9, 10) ensures a possibility of a fixed position of each pair relative to the frame, thereby allowing to form a large number of configurations of mounting of the receiving devices. Therewith, a type of the receiving device is not limited to the examples given below, but may be any type that is structurally capable of being fixed on the adapters (8, 9, 10) by means of corresponding connecting geometry or compatibility units. Thus, in the subject invention, the main role in variability of use is played precisely by the structural design and spatial arrangement of the adapters (8, 9, 10).

In one exemplary embodiment, the receiving device is a cradle (12), or a safety seat (13), or a basket (14). Therewith, the basket (14) may be used for transportation of a pet, e.g., a cat, a dog, or for transportation of cargo.

In another exemplary embodiment, the receiving device is a walking unit (15) comprising a seat (16) and a back (17) that are connected by hinge assemblies (18), wherein the back (17) is configured to adjust an inclination angle relative to the seat (16), and the walking unit (15) is configured to be mounted in two orientations relative to the movement direction of the stroller (1). It should be noted that in the figures in which the walking unit (15) is shown, it is shown without fabric finishing and soft elements for the sake of better illustration of structural details and assemblies of the walking unit (15).

In another exemplary embodiment of the invention, the receiving device is a wagon (19) that comprises a wagon frame that is made of at least two half-frames (20) that are interconnected by hinges (21) with the possibility of changing and fixing an inclination angle of each half-frame (20), a barrier (22), and being equipped with at least one seating place (23). The hinges (21) may be made, for example, in the form of pivot assemblies with a rotation axis installed at the corresponding ends of the half-frames (20), with the possibility of fixing their position by means of retainers interacting with toothed sectors, a series of holes or grooves formed on the elements of the half-frames (20). Fixation of the inclination angle of each half-frame (20) may be carried out, in particular, by means of a spring retainer, a locking pin, an eccentric clamp, and/or a screw clamp, which ensures the possibility of changing the angle of inclination of the half-frame (20), or reliable fixation. Also, the hinges (21) may form a unit comprising teeth and/or stops, which, when interacting with the corresponding ends of the half-frames (20), ensure limitation of movement of the half-frames (20) by at least two extreme fixed positions. Change of the inclination angle of the half-frames (20) may be carried out, for example, by pressing folding buttons located directly on the hinges (21) and kinematically connected with the retainers, with transferring the retainers into an unlocked state, rotating the half-frames (20) to a desired position, and subsequent automatic engagement of the retainers after release of said buttons. Also, change of the inclination angle of the half-frames (20) may be carried out by means of a hinge-lever and/or traction mechanism, wherein the user, while applying force to one of the half-frames (20), transfers it from an unfolded position to a semi-folded position, and after release of the half-frame (20), a spring retainer, eccentric clamp and/or screw clamp automatically fixes it in the achieved position. The wagon (19) may be equipped with a removal button that is kinematically connected to elements of the adapters (8, 9, 10), thereby ensuring easy and quick detachment of the wagon (19). Also, the wagon (19) may be equipped with additional accessories, for example, canopies, a table, handrails, etc.

Depending on the user needs and types of the receiving devices, three pairs of adapters (8, 9, 10) provide six (i), (ii), (iii), (iv), (v), (vi) configurations of operation positions of the adapters (8, 9, 10).

(i) the upper pair (8) of adapters, the middle pair (9) of adapters, and the lower pair (10) of adapters are in a position that is opposite to the operation position.

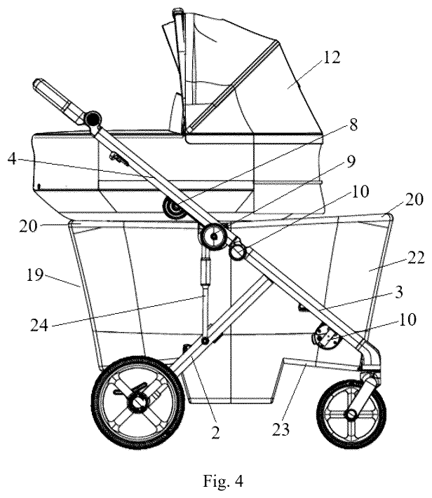

FIG. 4 shows a configuration (i), where the cradle (12) may be mounted on the upper pair (8) of adapters, while the wagon (19) may be mounted on the middle pair (9) of adapters, wherein the lower pair (10) of adapters is in the position that is opposite to the operation position, i.e., the lower adapters (10) are oriented downwardly relative to the supports (3) of the front wheels that does not avoid mounting of the wagon (19). It should be noted that the cradle (12) shown in FIG. 4 is provided merely as an example of the receiving device. In this configuration, instead of the cradle (12), another receiving device may be mounted on the upper pair (8) of adapters, in particular, the safety seat (13), the basket (14), or the walking unit (15). Said receiving devices (12, 13, 14, 15) may be mounted in two orientations relative to the movement direction of the stroller (1).

(ii) the middle pair (9) of adapters and the lower pair (10) of adapters are in the operation position.

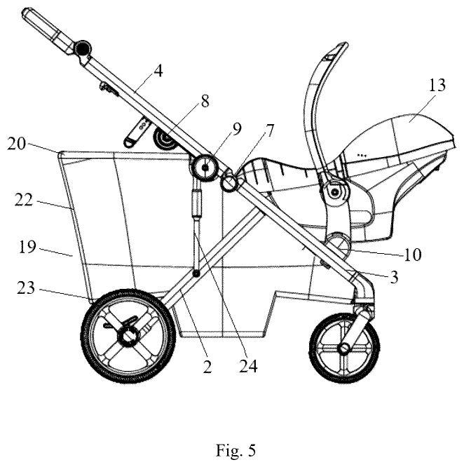

FIG. 5 shows the configuration (ii), where the wagon (19) in a semi-folded position may be mounted on the middle pair (9) of adapters, and the safety seat (13) may be mounted on the lower pair (10) of adapters in the operation position. It should be noted that the safety seat (13) shown in FIG. 5 is provided merely as an example of the receiving device. In this configuration, instead of the safety seat (12), another receiving device may be mounted on the lower pair (10) of adapters, in particular, the cradle (12), the basket (14), or the walking unit (15). Said receiving devices (12, 13, 14, 15) may be mounted in two orientations relative to the movement direction of the stroller (1).

(iii) the upper pair (8) of adapters and the lower pair (10) of adapters are in the operation position.

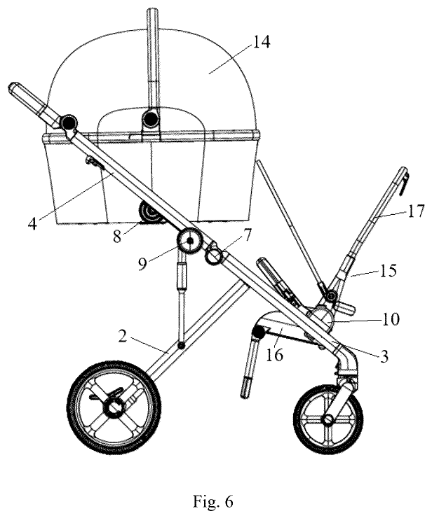

FIG. 6 shows the configuration (iii), where the bucket (14) may be mounted on the upper pair (8) of adapters, and the walking unit (15) may be mounted on the lower pair (10) of adapters in the operation position. It should be noted that the bucket (14) and the walking unit (15) shown in FIG. 6 are provided merely as examples of the receiving devices. In this configuration, instead of them, another receiving device may be mounted on the upper pair (8) of adapters or on the lower pair (10) of adapters, in particular, the cradle (12), the safety seat (13), the basket (14), or the walking unit (15). Said receiving devices (12, 13, 14, 15) may be mounted in two orientations relative to the movement direction of the stroller (1).

(iv) the middle pair (9) of adapters and the lower pair (10) of adapters are in a position that is opposite to the operation position.

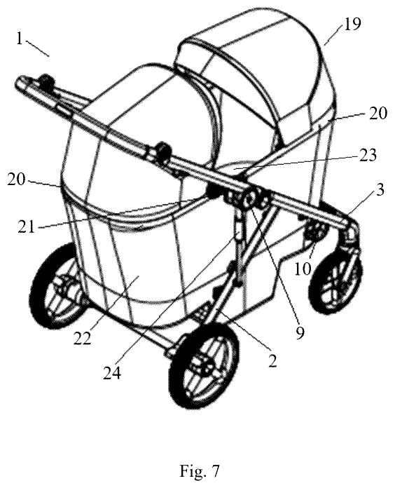

FIG. 7 shows the configuration (iv), wherein the wagon (19) in an unfolded position may be mounted on the middle pair (9) of adapters, the wagon is equipped with two seating places (23), which may be used for transportation of two children, while the lower pair (10) of adapters is in the position that is opposite to the operation position, i.e., the lower adapters (10) are oriented downwardly relative to the supports (3) of the front wheels, which does not inhibit mounting of the wagon (19).

(v) the middle pair (9) of adapters and the lower pair (10) of adapters are in a position that is different from the operation position or in a position that is opposite to the operation position.

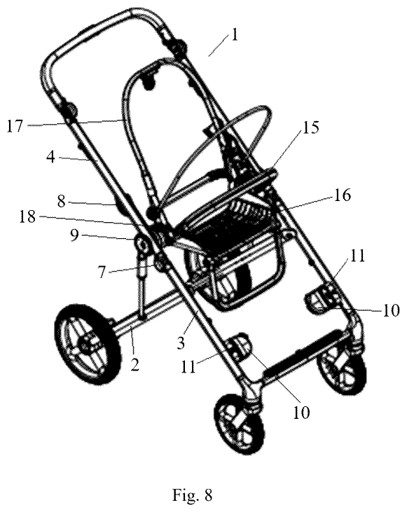

FIG. 8 shows the configuration (v), wherein the walking unit (15) may be mounted on the middle pair (9) of adapters, while the lower pair (10) of adapters, e.g., is in the position that differs from the operation position, i.e., the lower adapters (10) are oppositely oriented, or in the position that is opposite to the operation position, i.e., the lower adapters (10) are oriented downwardly relative to the supports (3) of the front wheels. It should be noted that the walking unit (15) shown in FIG. 8 is provided merely as an example of the receiving device. In this configuration, another receiving device may be mounted on the middle pair (9) of adapters instead of the walking unit, for example, the cradle (12), the safety seat (13), the basket (14), or the wagon (19) in the semi-folded position with one seating place (23). This configuration ensures transportation of one child. (vi) the upper pair (8) of adapters, the middle pair (9) of adapters, and the lower pair (10) of adapters are in the operation position.

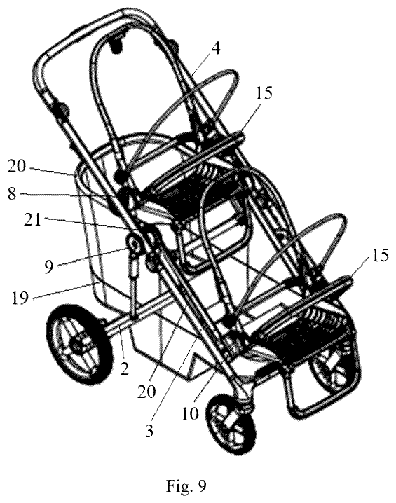

FIG. 9 shows the configuration (vi), wherein the walking unit (15) may be mounted on the upper pair (8) of adapters, the wagon (19) in the semi-folded position may be mounted on the middle pair (9) of adapters, and the walking unit (15) may be mounted on the lower pair (10) of adapters in the operation position. In this exemplary embodiment, the wagon (19) will act as the receiving device for transportation of cargo, e.g., toys, purchased items or clothes. It should be noted that the walking units (15) shown in FIG. 9 are provided merely as examples of the receiving devices. In this configuration, instead of them, another receiving device may be mounted on the upper pair (8) of adapters or on the lower pair (10) of adapters, in particular, the cradle (12), the safety seat (13), or the basket (14). Said receiving devices (12, 13, 14, 15) may be mounted in two orientations relative to the movement direction of the stroller (1).

It should also be noted that the above-described six configurations are implemented with the arrangement of the adapters (8, 9, 10) shown in the FIG. 1, FIG. 2 and FIG. 3.

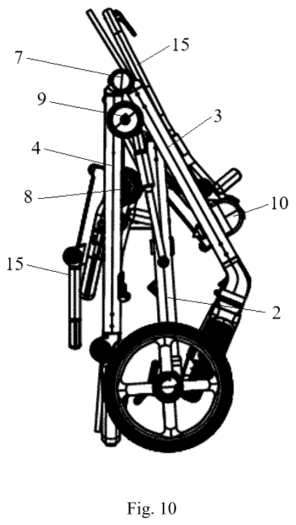

The walking unit (15) is configured to fold and unfold together with the frame of the stroller (1). The structure of the connecting assemblies of the walking unit (15), as well as its fixation on any pair of the adapters (8, 9, 10), ensure the possibility of folding and unfolding of the walking unit (15) together with the frame in any of the two orientations relative to the movement direction of the stroller (1). FIG. 10 shows two walking units (15) folded together with the frame of the stroller (1).

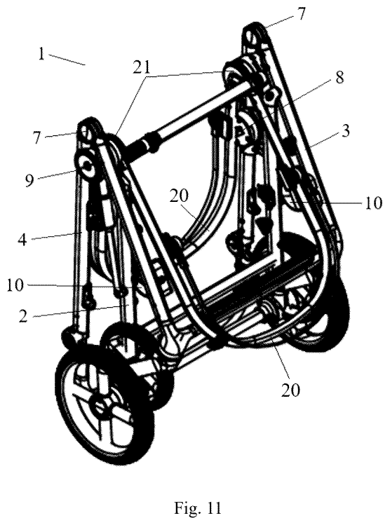

The wagon (19) is also configured to fold and unfold together with the frame of the stroller (1) as shown in FIG. 11, which is ensured by the presence of the hinges (21) between the half-frames (20) of the wagon (19). FIG. 11 shows the wagon (19) without the barrier (22) and without the seating places (23) for the sake of better illustration.

Due to the versatility of the three pairs of adapters (8, 9, 10) arranged on the frame of the stroller (1), two simultaneously mounted walking units (15) may be folded and unfolded together with the frame in two orientations relative to the movement direction of the stroller (1).

Similarly, the walking unit (15) and the wagon (19), which are simultaneously mounted on different pairs of adapters, may also be folded and unfolded together with the frame of the stroller (1) without any need in their prior removal.

In one of exemplary embodiments, the supports (4) of the handle comprise a mechanism (5) for adjusting the inclination angle of the handle (6). Said mechanism is given merely as an example of structural design. In other embodiments, the handle (6) may be made, for example, telescopic, pivotable, foldable, or having another mechanism for adjusting length or position, provided that the possibility of its installation on the supports (4) of the handle and compatibility with the frame structure is ensured.

The supports (4) of the handle are connected to the supports (2) of the rear wheels by shock-absorber supports (24). Therewith, the shock-absorber supports (24) may be combined with the middle pair (9) of adapters or with the upper pair (8) of adapters or between the middle pair (9) of adapters and the upper pair (8) of adapters, or outside the pairs (8, 9) of adapters.

Said structural design ensures achievement of expansion of the functional capabilities of the stroller due to the arrangement of the adapters, which have the structural design and mutual positioning that ensure simultaneous or selective mounting of one and/or two receiving devices for placement of one or two children of different age and weight with the possibility of varying their orientation relative to the movement direction of the stroller, increase of stability, and balance of the structure under action of load, prevention of accidental detachment or displacement of the adapters, as well as ensuring compactness of the stroller in the folded and unfolded positions and improvement of convenience in everyday use and during travel. Also, due to this design of the stroller, additional needs are covered upon appearance of a second child or a pet in the family without any need in purchasing separate strollers or transportation devices, which primarily has a positive impact on ecology, since this stroller has a long period of use, requires lower costs and resources for manufacturing than several different strollers, and thus contributes to reduction of the amount of waste after completion of operation.

1. A stroller (1) comprising a frame that comprises supports (2) of rear wheels, supports (3) of front wheels, and supports (4) of a handle, the supports (3) of the front wheels and the supports (4) of the handle are coupled via folding hinge assemblies (7) with a possibility of changing and fixing a position of the frame in a folded or unfolded states, and adapters, which are configured such that receiving devices can be mounted thereon, are mounted on the frame,
wherein
the stroller comprises three pairs of adapters, where the first pair of adapters is upper (8), the second pair of adapters is middle (9), and the third pair of adapters is lower (10);
wherein at least one pair of the upper (8) and middle (9) adapters is arranged on the supports (4) of the handle and at least one pair of the upper (8) and middle (9) adapters is removable;
wherein the pair of lower adapters (10) is arranged from inside of the supports (3) of the front wheels in close vicinity to the front wheels and is made non-removable, and each lower adapter (10) comprises a pivot mechanism (11) that is configured to change a position of the lower adapters (10), where, in an operation position, the lower adapters (10) are oriented upwards relative to the supports (3) of the front wheels,
and wherein the three pairs of adapters (8, 9, 10) provide the following six configurations of the operation positions of the adapters (8, 9, 10):
(i) the upper pair (8) of adapters, the middle pair (9) of adapters, and the lower pair (10) of adapters are in a position that is opposite to the operation position;
(ii) the middle pair (9) of adapters and the lower pair (10) of adapters are in the operation position;
(iii) the upper pair (8) of adapters and the lower pair (10) of adapters are in the operation position;
(iv) the middle pair (9) of adapters and the lower pair (10) of adapters are in a position that is opposite to the operation position;
(v) the middle pair (9) of adapters and the lower pair (10) of adapters are in a position that is different from the operation position or in a position that is opposite to the operation position;
(vi) the upper pair (8) of adapters, the middle pair (9) of adapters, and the lower pair (10) of adapters are in the operation position.

2. The stroller according to claim 1, wherein the receiving device is a cradle or a safety seat or a bucket.

3. The stroller according to claim 1, wherein the receiving device is a walking unit (15) comprising a seat (16) and a back (17) that are connected by hinge assemblies (18), wherein the back (17) is configured to adjust an inclination angle relative to the seat (16), and the walking unit (15) is configured to be mounted in two orientations relative to the movement direction of the stroller.

4. The stroller according to claim 3, wherein the walking unit (15) is made foldable and unfoldable together with the frame in two orientations.

5. The stroller according to claim 1, wherein the receiving device is a wagon (19) that comprises a wagon frame comprising at least two half-frames (20) that are interconnected by hinges (21) with the possibility of changing and fixing an inclination angle of each half-frame (20), a barrier (22), and being equipped with at least one seating place (23).

6. The stroller according to claim 5, wherein the wagon (19) is made foldable and unfoldable together with the frame.

7. The stroller according to claim 1, wherein the upper pair (8) of adapters and the middle pair (9) of adapters are arranged on the supports (4) of the handle above the folding hinge assemblies (7).

8. The stroller according to claim 1, wherein the middle pair (9) of adapters is arranged from inside on the folding hinge assemblies (7).

9. The stroller according to claim 1, wherein in a position that is opposite to the operation position, the lower adapters (10) are oriented downwards relative to the supports (3) of the front wheels.

10. The stroller according to claim 1, wherein in a position that differs from the operation position, the lower adapters (10) are oppositely oriented.

11. The stroller according to claim 1, wherein the supports (4) of the handle comprise a mechanism (5) for adjusting the inclination angle of the handle (6).

12. The stroller according to claim 1, wherein the supports (4) of the handle are connected to the supports (2) of the rear wheels by shock-absorber supports (24).
